(19) United States
(12) Patent Application Publication
(10) Pub. No.: US 2016/0093837 A1
(43) Pub. Date: Mar. 31, 2016

(54) Efficient Battery Pouch

(71) Applicant: Apple Inc., Cupertino, CA (US)

(72) Inventors: Tyler S. Bushnell, Cupertino, CA (US); Charles W. Werley, Cupertino, CA (US); John Chan, Cupertino, CA (US); Loren L. Roy, Cupertino, CA (US); Richard M. Mank, Cupertino, CA (US); Xiaoyun Hu, Cupertino, CA (US)

(21) Appl. No.: 14/870,996

(22) Filed: Sep. 30, 2015

Related U.S. Application Data
(60) Provisional application No. 62/057,987, filed on Sep. 30, 2014.

(51) Int. Cl. H01M 2/02; H01M 10/0525; H01M 10/04

(52) U.S. Cl. CPC H01M 2/0202; H01M 10/049; H01M 10/0525; H01M 2220/30

(57) ABSTRACT

The present disclosure discloses a battery pouch that includes a cavity. The battery pouch also includes a first transition between a first side of the battery pouch and a second side of the battery pouch. The first side of the battery pouch includes a first sealed portion having a minimum threshold distance between the cavity and the edge of the battery pouch. More specifically, the first sealed portion is located between a first outer edge of the cavity and a first outer edge of the battery pouch. The battery pouch also includes a second side having a second sealed portion with minimum threshold distance. Other embodiments are also described and claimed.

### CROSS-REFERENCE TO RELATED APPLICATION

This application claims the benefit under 35 U.S.C. §119(e) of U.S. Provisional Patent Application No. 62/057,987, filed on Sep. 30, 2014, and entitled “Efficient Battery Pouch,” which is incorporated by reference as if fully disclosed herein.

### TECHNICAL FIELD

This disclosure relates generally to a battery pouch, and more particularly to securing and aligning a space-efficient battery pouch within an electronic device.

### BACKGROUND

Portable electronic devices, such as smart phones, tablet computing devices, wearable computing devices, laptop computers, media players, and the like, use batteries to operate when an external power source is not available. Recently, lithium ion polymer batteries have been used extensively for portable electronic devices. Typically, a pouch or case is used to hold such a battery. The battery pouch may be formed from a sheet that is folded onto itself to form an interior void space; the sheet may be sealed to enclose the battery.

Many portable electronic devices attempt to maximize space utilization of internal components, including the battery and its pouch, so that such devices may have a relatively small form factor. The premium on internal space is in tension with the size of the battery, insofar as larger batteries provide greater power and thus permit the electronic device to operate longer between charges.

Usually a battery pouch case is sealed after all the components of the lithium ion battery have been mounted therein. The sealed multilayer laminate sheet of the battery pouch prevents the electrode assembly of the lithium battery from reacting with the external moisture, oxygen and other contaminants. The sealed multilayer sheet also prevents or mitigates any leakage of the electrode material thus preventing damage to other components of the portable electronic device.

In many devices, a minimum threshold distance is established for the pouch. The minimum threshold distance indicates how close an edge of the pouch (or an edge of the seal, in some embodiments) may be to the interior void space. If the flap of the pouch has a width below the minimum threshold distance, the pouch may be susceptible to tearing or breaking, and/or the seal may be susceptible to failing.

### SUMMARY

One embodiment takes the form of a battery pouch, comprising: a cavity; a first side comprising a first sealed portion defining a minimum threshold distance, wherein the first sealed portion is located between a first outer edge of the cavity and a first outer edge of the battery pouch; a second side comprising a second sealed portion having the minimum threshold distance, wherein the second sealed portion is located between a second outer edge of the cavity and a second outer edge of the battery pouch; and a first transition disposed between the first side and the second side, such that a nearest point of the transition is offset from a corner of the cavity by the minimum threshold distance.

Another embodiment takes the form of a battery pouch, comprising: a cavity having first, second, and third edges; a flap extending from an outer edge of the cavity to form an edge of the battery pouch, and comprising: a first sealed region extending a first distance from the first edge of the cavity; and a first securement region spaced apart from the cavity by at least the first distance, the first securement region defining an aperture extending therethrough.

Still another embodiment takes the form of a method for manufacturing a battery, comprising: forming a cavity in a multilayer sheet; placing an electrode assembly in the cavity; folding the multilayer sheet onto itself to enclose the cavity; sealing the multilayer sheet along a perimeter of the cavity to create a sealed region; and creating a transition in the sealed portion between a first side of the battery pouch and a second side of the battery pouch such that a minimum threshold distance between the transition and the cavity is maintained.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1A illustrates a sample battery pouch, in an open position, that receives and protects a sample battery.

FIG. 1B illustrates the sample battery pouch of FIG. 1A, with the pouch partially closed.

FIG. 1C illustrates the sample battery pouch of FIG. 1B with the pouch fully closed.

FIG. 1D illustrates the sample battery pouch of FIG. 1C with the layers of the pouch exaggerated for clarity.

FIG. 2A illustrates a second sample battery pouch in an open position.

FIG. 2B illustrates the second sample battery pouch of FIG. 2A when closed.

FIG. 3 illustrates a third sample battery pouch in an open position.

FIG. 4A illustrates the sample battery pouch of FIGS. 1A-1D, showing a relative position of the battery and battery tabs to the pouch.

FIG. 4B illustrates the sample battery pouch of FIGS. 1A-1D, showing an internal volume defined within the battery pouch and a minimum threshold distance.

FIG. 5 illustrates the sample battery pouch of FIGS. 1A-1D, having transitions at corners, offset from the internal volume by the minimum threshold distance.

FIG. 6 illustrates the sample battery pouch of FIGS. 1A-1D with securement apertures defined therein.

FIG. 7 illustrates a sample electronic device that may incorporate a space-efficient battery pouch, as described herein.

### DETAILED DESCRIPTION

The description that follows discusses several embodiments with reference to the appended drawings. Whenever the shapes, relative positions, and other aspects of the parts described in the embodiments are discussed or disclosed, it is intended the scope of the disclosure is not limited only to those parts shown, which are meant for merely for the purpose of illustration, but encompass other variations, dimensions, sizes, shapes, and so forth. It should be understood that described structures, methods, and the like may be practiced in a variety of forms in addition to those described herein. In other instances, well-known structures and methods have not been shown in detail so as not to obscure the understanding of this description.

Embodiments disclosed herein are directed to battery pouches for housing batteries for various portable electronic devices or electronic devices. These devices may include mobile phones, handheld devices, tablet computers, laptop computers, health devices, electronic glasses, wearable electronic devices, time-keeping devices, and the like. More specifically, embodiments disclosed herein are directed to battery pouches having sealed flaps configured to maintain a minimum threshold distance, as discussed below, while being space-efficient and having a reduced flap and/or seal (in at least one dimension). The reduced flap/seal may provide additional space for other electronic components within a volume-constrained environment, such as an interior of an electronic device.

According to embodiments, a battery pouch is made of a multilayer laminate sheet. To accomplish complete sealing, a sealed portion (also referred as a “sealed flap” or simply “seal”), which may extend around multiple sides of a pouch and generally sets and/or maintains a minimum threshold distance between an outer edge of the battery pouch and an inner cavity (and thus, a battery within the cavity). The minimum threshold distance is a minimum width (or other dimension) of the flap, below which the pouch seal may be too weak to maintain integrity of the pouch under certain conditions such as an impact, battery swelling, or the like. In some embodiments, the minimum threshold distance is a dimension of the seal and/or is set by a seal dimension. For example, if an entirety of the flap is sealed, then the minimum threshold distance is a minimum dimension of the seal necessary to maintain battery integrity. Thus, the term “minimum threshold distance” may be used with respect to either or both of the flap and seal.

In some embodiments, excess material of the flap of the battery pouch may be cut, removed, or otherwise modified to fit within the housing while not interfering with the other components in the housing. Generally, the closest point of the edge of the flap (or seal) is spaced from the cavity by the minimum threshold distance. Accordingly, edges of the flap (or seal) are at least the minimum threshold distance from the cavity.

In other embodiments, excess material of the battery pouch may be used to secure, align, compress or seal the battery pouch within the housing of the electronic device. For example, apertures may be formed in a portion of the flap that is spaced at least the minimum threshold distance from the cavity. Fasteners may pass through these apertures to secure the battery pouch to a portion of the electronic device, such as a substrate within the device.

In an embodiment, the present disclosure discloses a method of manufacturing a battery pack for an electronic device that includes a battery pouch. The method includes stamping, debossing, or otherwise forming a cavity in a multilayer sheet. An electrode assembly for a battery is then housed in the cavity. The multilayer sheet is then folded onto itself to enclose the cavity thus forming a battery pouch housing the electrode assembly. The folded multilayer sheets are then sealed along a perimeter of the cavity creating a sealed portion. The sealed portion maintains a minimum threshold distance between the between an outer edge of the cavity and an edge of the battery pouch. A transition is created in the sealed portion between a first side of the battery pouch and a second side of the battery pouch such that the minimum threshold distance between the cavity and the transition is maintained. In an embodiment, minimum threshold distance has a value approximately 1 mm to approximately 5 mm. In an embodiment, the minimum threshold distance has a value of approximately 2.5 mm. In an embodiment, the transition is flat, round, concave, convex, or tapered.

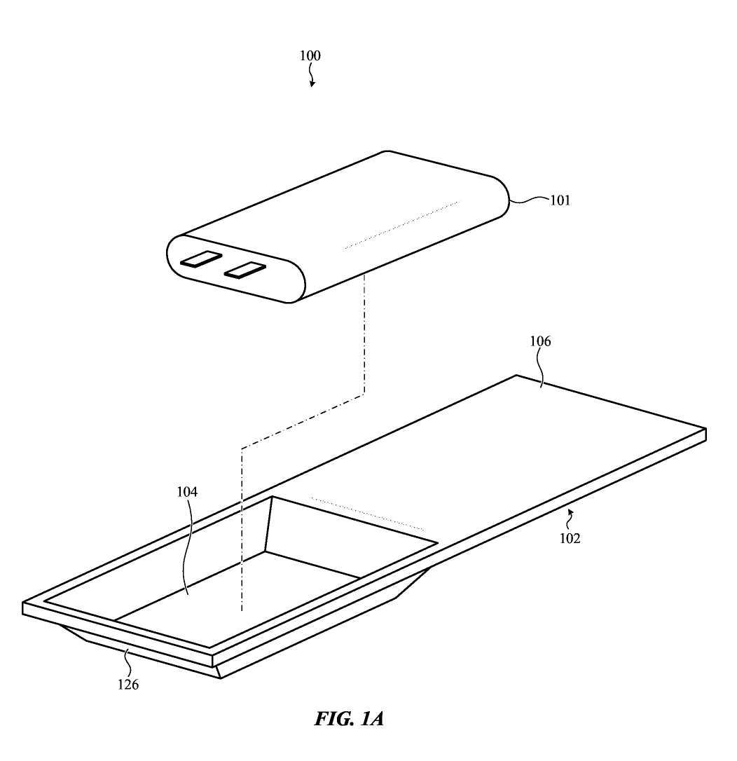

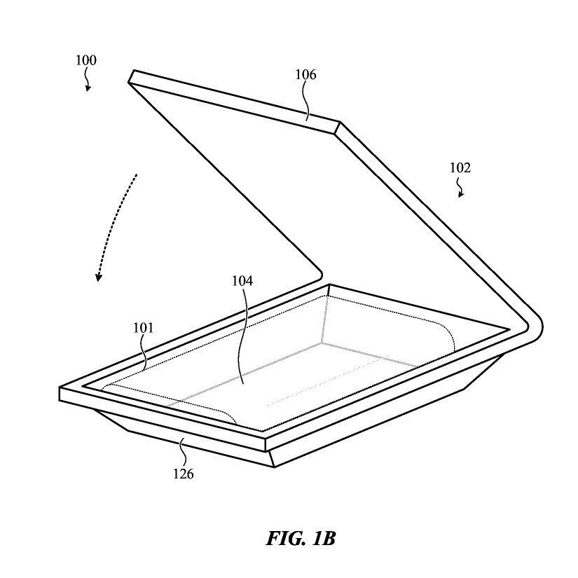

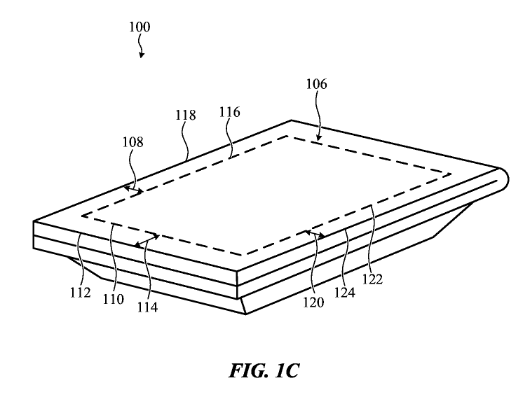

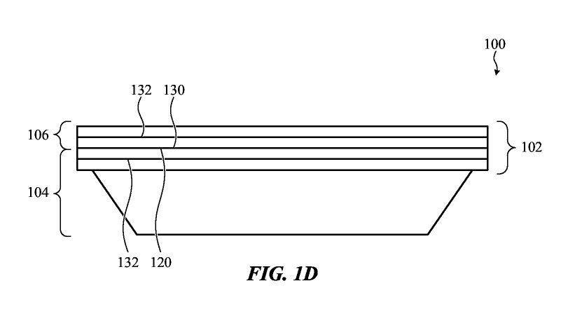

FIGS. 1A-1D illustrate a sample battery pouch 100. The battery pouch 100 may be created from a multilayer laminate sheet 102. Although specific materials are discussed herein, the battery pouch 100 may be constructed using other materials. The battery pouch 100 may be constructed by forming a cavity 104 in one portion, such as, for example, the bottom section 126 of the multilayer laminate sheet 102. A second portion of the battery pouch 100, such as, for example the top portion 106 may then be folded along a fold line to cover the cavity 104. In an embodiment, the fold line is perpendicular to the opposing edges of the sheet 102 as shown in FIG. 1.

The cavity 104 has a predetermined shape, in terms of width and depth, for accommodating a given electrode assembly of a battery 101. For example, as shown in FIG. 1, the cavity 104 may be generally rectangular. In other embodiments, the shape may be square, circular, triangular, and so on. In addition, the cavity may have one or more protrusions or cavities that are used to receive or house other components, modules or structures of the electronic device.

It should be appreciated that the illustrated shape is provided as but one non-limiting example; dimensions, relative positions of structural features, shapes, sizing, and the like all may vary between embodiments.

Returning to FIG. 1C, after receiving a given electrode assembly in the cavity 104, the top section 106 of the sheet 102 is folded to enclose the cavity 104. Once the top section 106 has been folded, the sheet 102 may be bonded together to seal the battery pouch 100 along a perimeter of the cavity 104. More specifically, the bonded portion forms a first sealed portion 108, a second sealed portion 114, and a fourth sealed portion 120.

As shown in FIG. 1C, the first sealed portion 114 extends from the first edge 110 of the cavity 104 to the first outer edge 112 of the battery pouch 100. The second sealed portion 108 extends from the second (e.g., left, in the view of FIG. 1C) edge 116 of the cavity 104 to the second outer edge 118 of the battery pouch 100. The third sealed portion 120 extends from the third (e.g., right, in the view of FIG. 1C) edge 122 of the cavity 104 to the third outer edge 124 of the battery pouch 100. In an embodiment, the first sealed portion 108, a second sealed portion 114, and a fourth sealed portion 120 maintain a minimum threshold distance. The minimum threshold distance helps ensure that is battery pouch 100 is sealed. The seal of the battery pouch 100 helps prevent contaminants from entering the battery pouch 100 and corroding or otherwise affecting the electrode assembly inside the battery pouch. In an embodiment, the minimum threshold distance is approximately 1 mm to approximately 5 mm. In yet another embodiment, the minimum threshold distance is approximately 2.5 mm.

FIGS. 1C and 1D show views of a closed pouch 100. In an embodiment, a multilayer laminate sheet comprises an inner sealant layer 130 and an outer metal layer 132. The layers may be bonded together using, for example, dry lamination, heat lamination, or extrusion lamination to form the multilayer sheet 102. In other embodiments, a multilayer sheet may comprise more than two layers. As one example, the outer layer may be a metal, a middle layer may be a puncture-resistant, nonconductive material such as a polymer or the like, and an inner layer may be a sealant layer. The sealant layer may have adhesive disposed over part or all of it, in certain embodiments. Further, the sealant layer may be a material that can be bonded or fused to itself, for example by heating, to create a seal.

The inner sealant layer 130 may be in direct contact with an electrode assembly of a battery (not shown). In an embodiment, the inner sealant layer is a polymer. The inner sealant layer may be composed of a polyolefin-based polymer such as, but not limited to, polypropylene, chlorinated polypropylene, polyethylene, ethylene-propylene copolymer, polyethylene-acrylic acid copolymer, and polypropylene-acrylic acid copolymer. In an embodiment, the inner sealant layer is casting polypropylene film. The inner sealant layer 130 provides insulation to the electrode assembly of the battery as well as providing a barrier to external moisture, oxygen and contaminants. The outer metal layer 132 may act as a barrier to external moisture, oxygen and other contaminants. In addition, the outer metal layer may help maintain the strength of the battery pouch 100. The outer metal layer 132 may be constructed from various metals such as, but not limited to, aluminum, nickel, steel or other alloys, and the like.

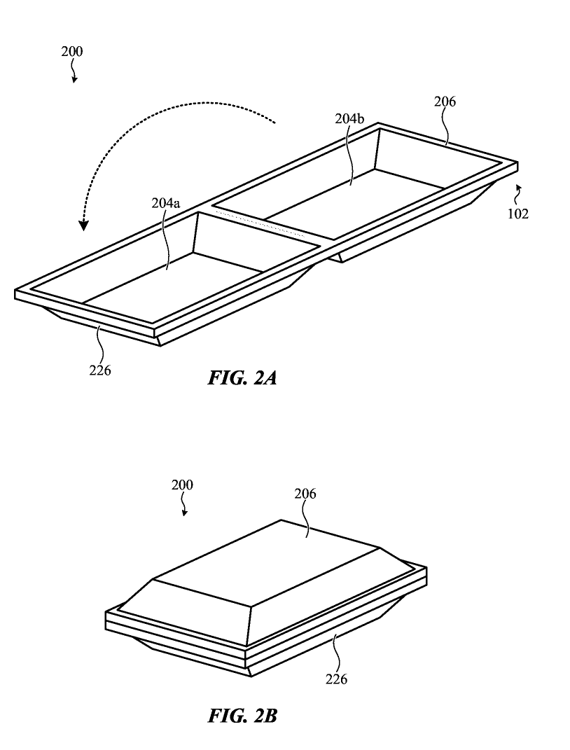

FIGS. 2A and 2B illustrate yet another embodiment of a battery pouch. Here, the top portion 206 and bottom section 226 may be mirror images of one another (e.g., they may be mirrored about the illustrated fold line). Further, the top portion 206 may form a top cavity segment 204a and the bottom portion 226 may form a bottom cavity segment 204b; the top and bottom cavity segments 204a, 204b may be approximately equal in their dimensions. Alternately, the top portion 206 and bottom portion 226 may each be recessed and cooperate to form a cavity 104, but the top and bottom portions may be recessed to different depths instead of being mirror images.

It should be appreciated that the sheet 102 may be flexible or partially flexible. For example, the sheet 102 may be debossed, punched, or otherwise manipulated to form a recess 104 in which a battery 101 sits. The portion of the sheet 102 forming the cavity may be reinforced, strengthened, or otherwise may partially or fully rigid, in certain embodiments. The top portion 106 may remain flexible or may also be strengthened. In some embodiments, an insert may be placed within the cavity to strengthen the sheet 106 in this manner. In certain embodiments, only a portion of the sheet may be made rigid or otherwise strengthened.

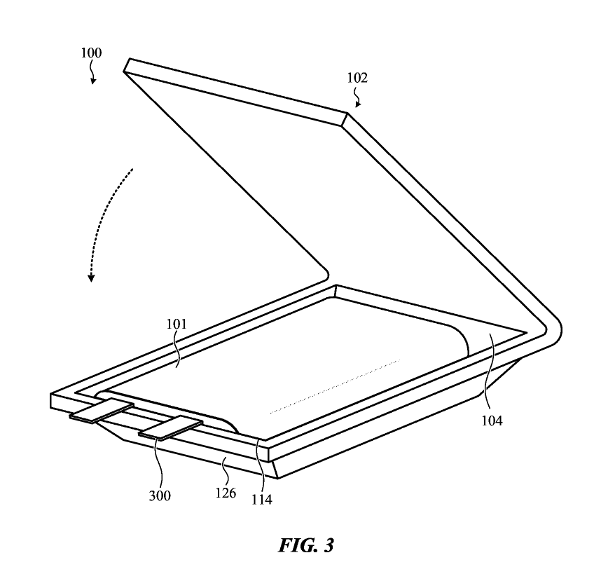

FIG. 3 shows a battery 101 received within a sample battery pouch 100. As shown in FIG. 3, the terminals or leads 300 of the battery 101 may extend from the interior of the pouch 100. The terminals may extend through a seal and/or flap of the pouch, thereby permitting electrical components to draw power from the battery. The sheet 102 may be adhered to the leads 300 on one or both sides of the part of the sheet forming the flap.

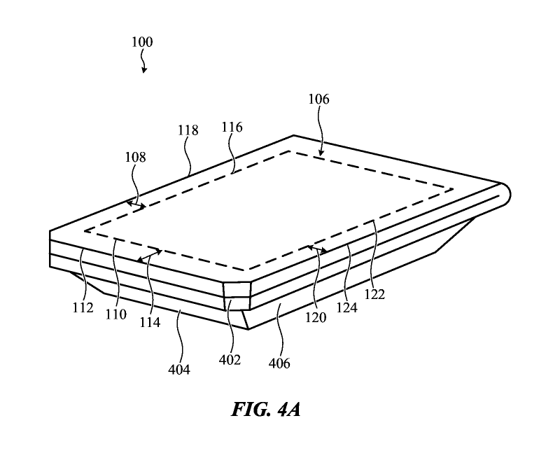

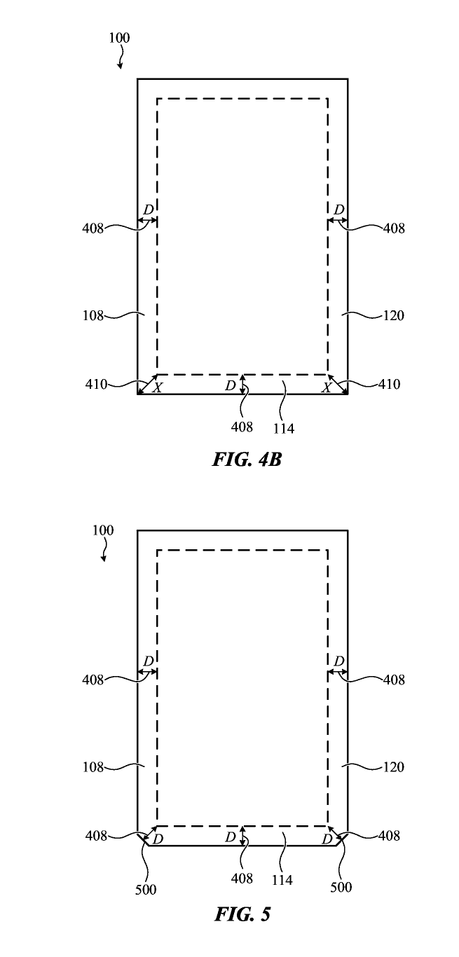

FIG. 4 illustrates a sample battery pouch 100 having transitions 402 formed thereon. The transitions 402 are angled regions extending between adjacent sides or edges of the battery pouch 100; as shown, the transitions may extend at non-right angles from adjacent edges of sealed regions or seals. The transitions 402 may reduce the area and volume occupied by the flap and/or seal of the battery pouch 100. This, in turn, may free additional space within an electronic device for occupancy by other components of the device.

In embodiments, the battery pouch 400 may be similar to the battery pouches shown and described above. As shown in FIG. 4, one transition 402 is positioned between a first seal 114 and a second seal 108 of the battery pouch 400, and particularly extends from the first edge 112 to the second edge 118. Another transition 404 may extend from the first seal 114 to the third seal 120. More particularly, the second transition 402 may extend from an outer edge 112 of the first seal to an outer edge 124 of the third seal 120.

The transitions 402 reduce the overall area of the flap. The angled transitions 402 each may be offset from a nearest corner of the cavity 104 by the minimum threshold distance, at least at a nearest point of the transitions 402. Thus, the seal (or flap) of the battery pouch always maintains an offset of the minimum threshold distance from the cavity, but the overall flap/seal occupies less area and/or volume.

In certain embodiments, the minimum threshold distance may be between approximately 1 mm to approximately 5 mm. In yet another embodiment, the minimum threshold distance is approximately 2.5 mm. Although specific measurements have been given, the minimum threshold distance may have a variety of distances. Further, the minimum threshold distance may be different on the various sides of the battery pouch 100. For example, the first transition may have a first minimum threshold distance and the first side may have a second, different minimum threshold distance. In another example, each side and transition of the battery pouch 100 may have different or similar minimum threshold distances.

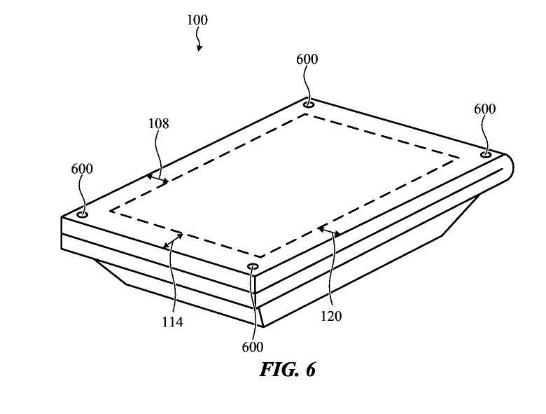

It should be appreciated that the transitions 402 need not be linear. Either or both of the first transition 402 and the second transition 404 may be flat, round, concave, convex or tapered and so on. For example, the first and second transitions 402 may have a constant radius D (e.g., a constant radius equal to the minimum threshold distance). This may be even more space-efficient than the battery pouch shown in FIG. 5, insofar as no portion of the sealed flap extends more than the minimum threshold distance from the cavity.

As yet another option, the first transition 402 may have a first shape while the second transition 404 has a second shape. Likewise, the battery pouch 400 may have only one transition. Further, although FIG. 4 shows two transitions there may be more than two transitions in some embodiments. For example, each edge and/or corner of the battery pouch 400 may include or define a transition.

In addition to the above, each transition may have similar or substantially similar lengths and/or angles. In other embodiments, each transition may be different lengths and/or angles. The transitions may be created by cutting, abrading, or otherwise removing part of the sheet 102 (either before or after closing the pouch) or by folding the sheet 102. For example, a corner of the sheet may be folded underneath an adjacent part of the sheet to form the transition.

FIGS. 5A and 6 illustrate spatial savings of a pouch due to the use of transitions. FIG. 5A shows a battery pouch 100 before any transitions 402 are formed. As shown in the top view of FIG. 5A, the outer edge of each sealed region 108, 114, 120 (or portion of a flap) is offset along its length from an interior cavity by a distance D 408. Each corner is offset from a corner of the interior cavity 104 by a distance X 410. As can be appreciated, X is necessarily greater than D. In the example shown in FIG. 5A, X=(√2)(D). The exact value of X may vary depending on the relative dimensions of the adjacent sealed portions.

FIG. 6 illustrates a view of the battery pouch 100, after transitions 402 are formed at the corners of the flap. Just as outer edges of the first, second and third sealed portions 114, 108, 120 are spaced from cavity edges by distance D 408, so too is a nearest of each transition 402 spaced apart from the closet corner of the cavity. Any other point on the outer edge of the transition 402 is spaced apart from a nearest portion of the cavity by a distance greater than D.

FIG. 6 illustrates a perspective view of a sealed battery pouch 100 having a cavity 602 that receives an electrode assembly of a battery (not shown). Here, one or more securement apertures 600 may be formed through parts of the flap that are removed by more than a minimum threshold distance from the inner cavity 104.

For example, the flap may include a first sealed region 114 that extends at least a minimum threshold distance from the cavity 104. Likewise, second and third sealed regions 108, 120 may extend at least the minimum threshold distance from edges of the cavity.

Securement apertures 600, or other securement structures, may be formed in parts of the flap that are offset from the cavity 104 by more than the minimum threshold distance. Such features may be formed in a part of the flap that would otherwise be removed to form a transition, as described above.

Generally, the securement apertures may accept a mechanical fastener and so enable the battery pouch 100 to be coupled to a housing of the electronic device, or other structure of the electronic device (such as an internal plate, support, substrate, or the like). In some instances the through holes may be used to align the pouch, as well. Although four apertures are shown in FIG. 6, the battery pouch 600 may include fewer or more than four apertures.

The securement apertures may also have or be formed in an extended area of the sheet material, such as an extended polymer layer. In some embodiments, the polymer layer may define and/or be used for sealing the through holes with a housing of a portable device. As one example, the polymer layer may be melted or heat-formed about a mechanical fastener in an aperture to secure the fastener to the sheet.

Further, securement regions may act as an insulator for other components of the portable device. A securement region may be formed from one or more layers of the sheet 102. As one example, a polymer layer may extend past an edge of a metal layer and be used to form the securement region. The polymer layer may extend only partially, unevenly, and/or otherwise in particular areas to form the securement region(s).

In some embodiments, the securement region and/or other portions of the battery pouch (such as the sealed portions 108, 114, 120) may be used to secure, conceal, and/or compress components located between the securement region (or other portion of the battery) and a substrate to which the pouch is affixed. The securement region and/or sealed regions may thus function as a securement and/or compression mechanism, insofar as the mechanical fastener holding the pouch to the housing or other surface may cause the securement/sealed region to exert a compressive force on such components. Likewise, in certain embodiments the securement region and/or sealed regions may protect components beneath them from impact, debris, liquids and the like. Further, these regions may conceal a component located beneath them. It should be appreciated that these components may not be part of the battery, but can be completely separate.

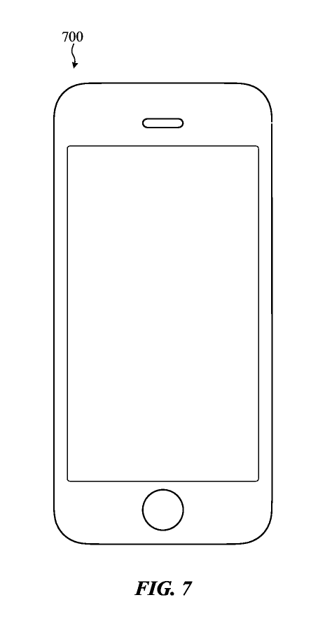

FIG. 7 illustrates a sample electronic device that may incorporate or otherwise use a battery pouch have space-saving and/or securement features, as described herein. Although the device 700 is shown as a phone, it should be appreciated that the device may take many different forms, including a portable computer, a desktop computer, a server, a tablet computing device, a wearable computing device, a media player, and so on. In many cases, smaller electronic devices may benefit more from space-efficient battery pouches as described herein, since internal space is typically at a higher and higher premium as the size of an electronic device decreases.

Transitions and/or securement regions may be formed in or on any battery pouch described herein. Accordingly, it should be understood that various features and structures described herein are not limited to particular embodiments, even if described with respect to particular embodiments. Furthermore, such features, structures, and the like may be combined within a single battery pouch 100.

Certain embodiments may take the form of a method of manufacturing a battery pack for an electronic device that includes a battery pouch. The method includes stamping a cavity in a multilayer sheet. An electrode assembly, which may be a battery or a portion of a battery, is then housed in the cavity. The multilayer sheet is then folded onto itself to enclose the cavity thus forming a battery pouch housing the electrode assembly.

The folded sheet is then sealed along a perimeter of the cavity to create a flap.

In certain embodiments, one or more transitions may be formed at corners of the flap. At least at a nearest point of the transition edge to a corner (or other nearest point) of the cavity may be separated by the minimum threshold distance.

In some embodiments, the flap includes a sealed region and a securement region. The sealed portion may extend a first distance (e.g., a minimum threshold distance) from an outer edge of the cavity. The securement portion, if any, may extend a second distance from the outer edge of the sealed portion to an edge of the battery pouch. In embodiments including the optional securement region, a securing mechanism, such as a fastener, may extend through an aperture in the securement region. The securing mechanism may be a mechanical fastener such as a rivet, screw, boss, or the like.

Generally, the first distance of the sealed portion (e.g., the minimum threshold distance) is approximately 1 mm to approximately 5 mm. In some embodiments, the first distance of the sealed portion has a value of approximately 2.5 mm.

The present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. A battery pouch comprising:
a cavity;
a first side comprising a first sealed portion defining a minimum threshold distance, wherein the first sealed portion is located between a first outer edge of the cavity and a first outer edge of the battery pouch;
a second side comprising a second sealed portion having the minimum threshold distance, wherein the second sealed portion is located between a second outer edge of the cavity and a second outer edge of the battery pouch; and
a first transition disposed between the first side and the second side, such that a nearest point of the transition is offset from a corner of the cavity by the minimum threshold distance.

2. The battery pouch of claim 1, further comprising
a third side comprising a fourth sealed portion having a minimum threshold distance, wherein the fourth sealed portion is located between a third outer edge of the cavity and a third outer edge of the battery pouch; and
a second transition disposed between the second side and the third side, wherein the second transition is offset from a second corner of the cavity by the minimum threshold distance.

3. The battery pouch of claim 1, wherein at least one of the first and the second transition is convex.

4. The battery pouch claim 2, wherein at least one of the first and second transitions is formed from a folded edge.

5. The battery pouch of claim 1, wherein the minimum threshold distance is between 1 mm and 5 mm.

6. The battery pouch of claim 1, wherein the minimum threshold distance is 2.5 mm.

7. A battery pouch, comprising:
a cavity having first, second, and third edges;
a flap extending from an outer edge of the cavity to form an edge of the battery pouch, and comprising:
a first sealed region extending a first distance from the first edge of the cavity; and
a first securement region spaced apart from the cavity by at least the first distance, the first securement region defining an aperture extending therethrough.

8. The battery pouch of claim 7, wherein the flap further comprises:
a second sealed region extending the first distance from the second edge of the cavity;
a second securement region that extends the second distance from the second sealed portion to the edge of the battery pouch;
a third sealed region that extends the first distance from the third edge of the cavity; and
a third securement region that extends the second distance from the third sealed portion to the edge of the battery pouch.

9. The battery pouch of claim 8, wherein the first distance is approximately 1 mm to approximately 5 mm.

10. The battery pouch of claim 8, wherein the first securement region is an extension of, and contiguous with, the first sealed region.

11. The battery pouch of claim 7, further comprising a mechanical fastener extending through the aperture.

12. The battery pouch of claim 11, wherein the first sealed region is configured to secure a component beneath the first sealed region.

13. The battery pouch of claim 7, wherein the securement region comprises a polymer sheet.

14. A method of manufacturing a battery, comprising:
forming a cavity in a multilayer sheet;
placing an electrode assembly in the cavity;
folding the multilayer sheet onto itself to enclose the cavity;
sealing the multilayer sheet along a perimeter of the cavity to create a sealed region; and
creating a transition in the sealed portion between a first side of the battery pouch and a second side of the battery pouch such that a minimum threshold distance between the transition and the cavity is maintained.

15. The method of claim 14, wherein:
all edges of the sealed region are spaced from nearest points on edges of the cavity by at least the minimum threshold distance; and
the minimum threshold distance is approximately 1 mm to approximately 5 mm.

16. The method of claim 15, wherein the transitions extend at non-right angles from adjacent edges of the sealed region.

17. The method of claim 16, wherein the transition forms a straight edge.

18. The method of claim 16, wherein the operation of forming a cavity in the multilayer sheet comprises stamping the cavity.

19. The method of claim 14, wherein the operation of placing the electrode assembly in the cavity comprises placing the electrode assembly in the cavity such that at least one lead of the electrode assembly extends out of the cavity.

20. The method of claim 19, wherein the operation of sealing the multilayer sheet comprises sealing the multilayer sheet, at least in part, to the at least one lead.
